(19) United States
(12) Patent Application Publication
(10) Pub. No.: US 2002/0010712 A1
(43) Pub. Date: Jan. 24, 2002

(54) Information processing method and apparatus

(76) Inventor: Hiroyuki Kimura, Kanagawa (JP)

Correspondence Address: FITZPATRICK CELLA HARPER & SCINTO, 30 ROCKEFELLER PLAZA, NEW YORK, NY, 10112, US

(21) Appl. No.: 09/867,494

(22) Filed: May 31, 2001

(30) Foreign Application Priority Data
Jun. 5, 2000 (JP) 168089/2000

(51) Int. Cl. G06F 15/00

(52) U.S. Cl. 707/501.1

(57) ABSTRACT

An information processing apparatus monitors the playback status of a plurality of pieces of media information which are being played back, and acquires measurement information as a monitoring result. Playback of the media information is limited based on the measurement information and the priorities of the plurality of pieces of media information that are set in advance. When the measurement information represents that the playback speed of media information is insufficient, the number of pieces of media information to be played back is decreased. When the measurement information represents that the playback speed is sufficient, the number of pieces of media information to be played back is increased. In this manner, priorities are set for media data to be simultaneously played back, and when playback processing by a computer delays, playback of data is limited from a low priority.

### FIELD OF THE INVENTION

The present invention relates to an information processing method and apparatus capable of playing back a plurality of types of media information.

### BACKGROUND OF THE INVENTION

In general, a personal computer and workstation (to be referred to as personal computers hereinafter) can play back multimedia data such as computer graphics (CG), moving pictures, animation, still pictures, text, and sound. These multimedia data are recorded on, e.g., a CD-ROM disk, and the personal computer can load the multimedia data from a connected CD-ROM device and play them back. With the recent development of the Internet, multimedia data of a site on the Internet can be downloaded to a personal computer via a network and played back on the personal computer.

A file including a plurality of multimedia data such as moving pictures and text has conventionally been created and loaded to a personal computer to sequentially play back the data, like Director and Shockwave available from Macromedia. In recent years, standards such as W3C (World Wide Web Consortium) and SMIL (Synchronized Multimedia Integrated Language) are recommended, implementing a method of saving respective multimedia data as separate files, parallel-loading the data to a personal computer, and playing back various multimedia data while synchronizing them with each other. Note that the contents of Director, Shockwave, and SMIL have already been known, and a detailed description thereof will be omitted.

In playing back multimedia data on a personal computer, a poor performance of the personal computer causes interrupted playback or a playback failure because multimedia playback processing cannot be completed within a necessary time. Similarly, interrupted playback or a playback failure occurs also when the loading rate of multimedia data from a CD-ROM device is low or the transfer rate of multimedia data is low due to a thin Internet access line.

To solve these problems, some personal computers have a function of checking in advance the performance of a video playback board mounted in a personal computer and changing the processing level in accordance with the board performance to complete playback within a predetermined time. Further, some personal computers have a function of determining the network transfer rate and changing the quality of data to be transferred when moving picture data is to be downloaded via a network.

These functions act only for data of a single medium, and do not satisfactorily act for a plurality of multimedia data. For example, when a personal computer is to simultaneously play back a plurality of multimedia data by using SMIL or the like and exceeds the performance of the personal computer or the data transfer ability, these data cannot be appropriately adjusted.

When the operator of a personal computer cannot simultaneously play back multimedia on an operated personal computer or cannot transfer multimedia data to be simultaneously played back owing to a thin network line, this influences all multimedia data to be played back. For example, when a plurality of multimedia data cannot be played back, the operator cannot select a medium to be played back such as sound he/she wants to listen to or text he/she wants to read, or cannot play back only the selected medium.

### SUMMARY OF THE INVENTION

The present invention has been made to overcome the conventional drawbacks, and has as its object to enable setting priorities for data to be simultaneously played back and when playback processing delays, limiting playback of data from a low priority.

To achieve the above object, an information processing apparatus according to an aspect of the present invention has the following arrangement.

That is, an information processing apparatus comprises

playback means for playing back a plurality of pieces of media information,

monitoring means for monitoring a playback status of the plurality of pieces of media information in the playback means,

storage means for storing priority information representing priorities of the plurality of pieces of media information, and

limiting means for limiting playback of the media information in the playback means on the basis of a playback status monitoring result of the monitoring means and the priority information.

To achieve the above object, an information processing method according to another aspect of the present invention has the following steps.

That is, an information processing method comprises

the playback step of playing back a plurality of pieces of media information,

the monitoring step of monitoring a playback status of the plurality of pieces of media information in the playback step,

the storage step of storing priority information representing priorities of the plurality of pieces of media information in storage means, and

the limiting step of limiting playback of the media information in the playback step on the basis of a playback status monitoring result in the monitoring step and the priority information.

Other features and advantages of the present invention will be apparent from the following description taken in conjunction with the accompanying drawings, in which like reference characters designate the same or similar parts throughout the figures thereof.

### BRIEF DESCRIPTION OF THE DRAWINGS

The accompanying drawings, which are incorporated in and constitute a part of the specification, illustrate embodiments of the invention and, together with the description, serve to explain the principles of the invention.

FIG. 1 is a block diagram showing a system configuration according to the first embodiment;

FIG. 2 is a view showing a state in which multimedia data are played back in synchronism with each other;

FIG. 3 is a view showing a playback priority setting dialog according to the first embodiment;

FIG. 4 is a flow chart for explaining a playback processing sequence according to the first embodiment;

FIG. 5 is a flow chart showing monitoring processing for playback processing according to the first embodiment; and

FIG. 6 is a view showing a window display example according to the first embodiment.

### DETAILED DESCRIPTION OF THE PREFERRED EMBODIMENTS

Preferred embodiments of the present invention will now be described in detail in accordance with the accompanying drawings.

[First Embodiment]

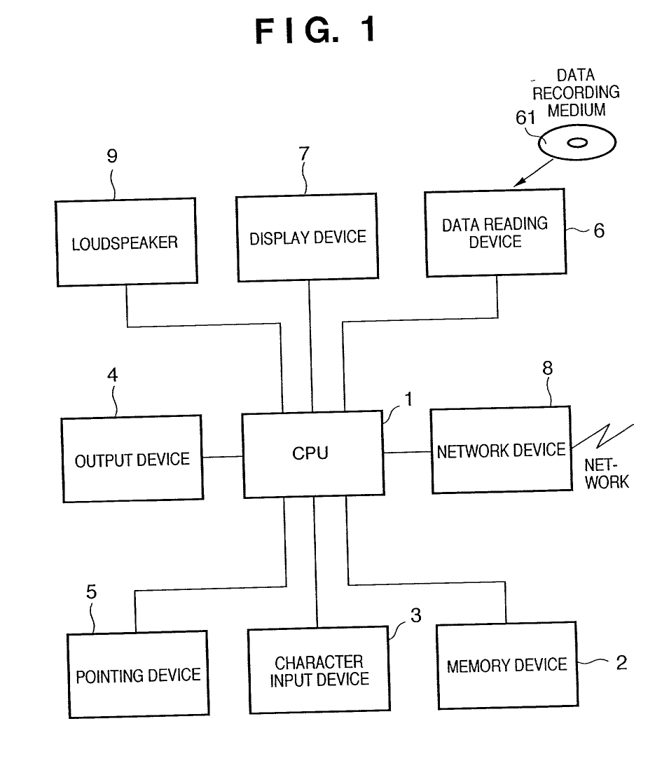

FIG. 1 is a block diagram showing a system configuration according to the first embodiment. In FIG. 1, reference numeral 1 denotes an arithmetic & control device such as a CPU which performs various arithmetic operations and controls the overall system. In this case, the “CPU” means not a processing chip but the main body of a personal computer. The CPU 1, therefore, includes a microprocessor, ROM, and RAM (none of them are shown). Reference numeral 2 denotes a memory device such as a hard disk which stores arithmetic/control software executed by the CPU 1 and various data. If necessary, control software stored in the memory device 2 is loaded to the RAM in the CPU 1 so as to execute the control software by the microprocessor.

Reference numeral 3 denotes a character input device such as a keyboard. Information input via the character input device 3 is sent to the CPU 1. Reference numeral 4 denotes an output device such as a printer which is used to output the arithmetic result of the CPU 1 onto a recording medium such as paper; and 5, a pointing device such as a mouse. A coordinate position designated by the pointing device 5 is input to the CPU 1, and a cursor is displayed on a display device 7 (to be described later).

Reference numeral 6 denotes a data reading device such as a CD-ROM device. Multimedia data or a processing program is read from a data recording medium 61 such as a CD-ROM disk set in the data reading device 6, and is sent to the CPU 1.

The display device 7 comprises a CRT, LCD, or the like, and displays CG, moving pictures, animation, still pictures, and text of multimedia data input to the CPU 1. Reference numeral 8 denotes a network device such as a modem or LAN device. The network device 8 receives multimedia data or a program from a device such as another personal computer connected to the Internet or an intranet (neither is shown), and sends it to the CPU 1.

Reference numeral 9 denotes a loudspeaker which plays back sound data of multimedia data input to the CPU 1. This system is a general personal computer, the operation of each device has already been known, and a detailed description thereof will be omitted. The features of this embodiment will be explained below.

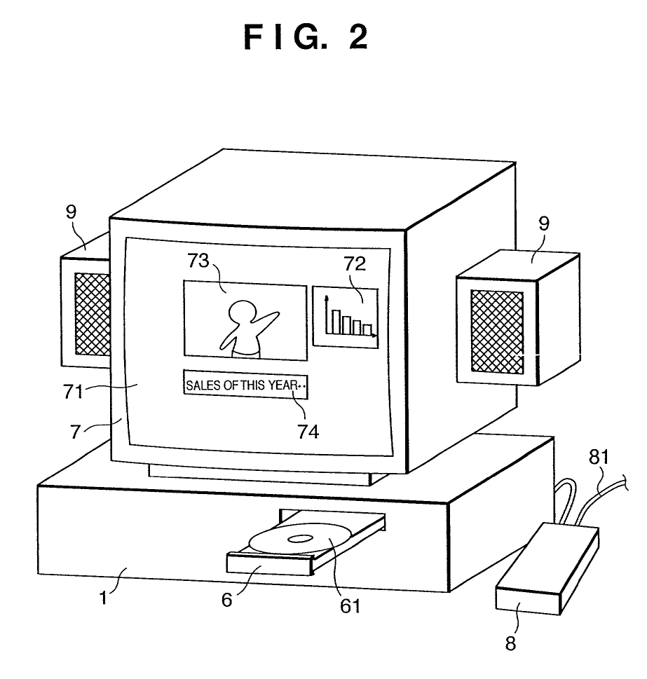

FIG. 2 is a view showing a state in which multimedia data are played back in synchronism with each other. In FIG. 2, the same reference numerals as in FIG. 1 denote the same parts, and a description thereof will be omitted.

In FIG. 2, multimedia data is transmitted via a cable 81 connected to the network device 8 such as a modem, and sent to the CPU 1. In another case, multimedia data recorded on the data recording medium 61 set in the data reading device 6 is read by the data reading device 6 and sent to the CPU 1.

In this embodiment, multimedia data sent to the CPU 1 include at least any of still picture data, moving picture data, text data, and sound data, and comply with SMIL. In FIG. 2, still picture data is decompressed by the CPU 1, converted into a format which can be displayed on the display device 7, and displayed as a still picture 72 of a graph on a screen 71 of the display device 7. Compreised moving picture data is decoded by the CPU 1, also converted into a format which can be displayed on the display device 7, and displayed in a moving picture region 73. Text data is converted by the CPU 1 into a character image which can be displayed on the display device 7, by using font data stored in the memory device 2 (not shown in FIG. 2), and displayed as a telop in a text region 74 at the speaking timing of a person's image of moving picture data. Sound data is decompressed by the CPU 1, converted into a format which can be played back by the loudspeaker 9, and played back as a sound from the loudspeaker 9 at the speaking timing of the person's image of moving picture data.

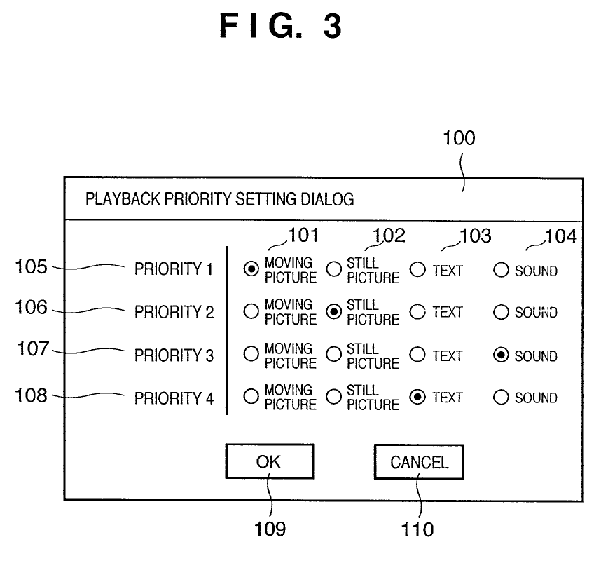

In this embodiment, priorities are set for multimedia data to be simultaneously played back, and when playback processing delays, playback of data is limited from a low priority. A sequence of setting the playback priorities of multimedia data will be explained with reference to FIG. 3.

FIG. 3 is a view showing a playback priority setting dialog according to the first embodiment. In this example, a dialog 100 shows four priorities 1 to 4 (105, 106, 107, and 108) because four types of multimedia data, i.e., moving picture data (101), still picture data (102), text data (103), and sound data (104) are played back.

In setting playback priorities, the operator displays the dialog 100 to select the moving picture data (101), still picture data (102), text data (103), and sound data (104) for priorities 1 to 4 (105, 106, 107, and 108). Each data is selected by a radio button, and the same data cannot be selected twice or more. For example, when the moving picture data (101) is selected for any of priorities 2 to 4 (106, 107, and 108) after the moving picture data (101) is selected for priority 1 (105), the selection is canceled. This method inhibits selection of two or more data for the same priority.

After setting the four priorities in this manner, the operator clicks an OK button 109 to send the setting contents to the CPU 1. The CPU 1 stores the setting information in the memory device 2, and the dialog ends. If the operator clicks a cancel button 110, the dialog ends without sending any setting values to the CPU 1. In the example of FIG. 3, priorities are set in an order of a moving picture, still picture, sound, and text.

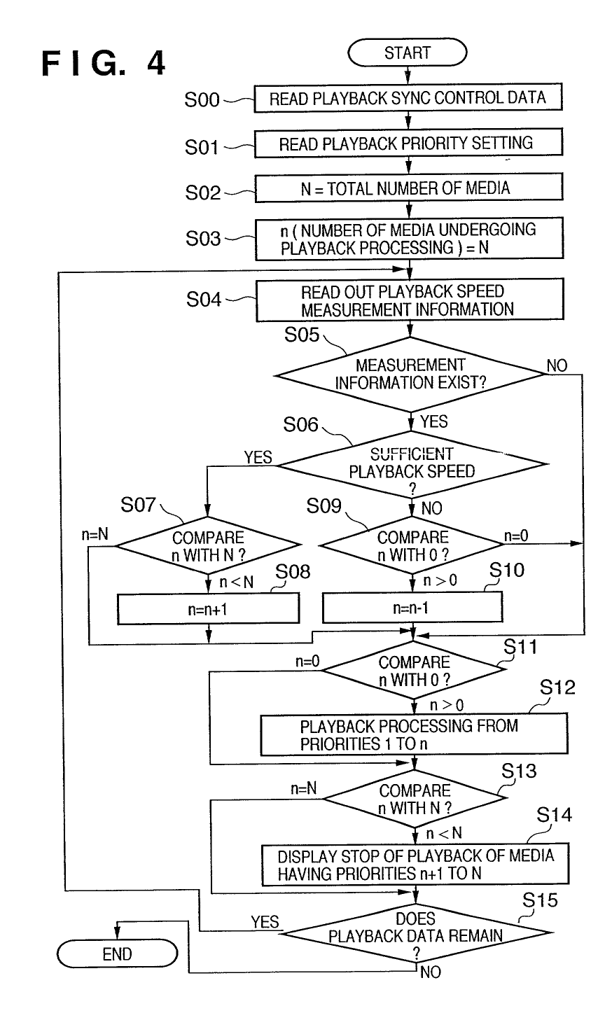

A multimedia data playback processing sequence using the priorities set in the above-described way will be explained with reference to the flow chart of FIG. 4. FIG. 4 is a flow chart for explaining a playback processing sequence according to the first embodiment.

Control data necessary for playing back a plurality of media in synchronism with each other is read in step S00, and the flow advances to step S01. Processing priority setting information described with reference to FIG. 3 is read out from the memory device 2 in FIG. 1 in step S01, and the flow advances to step S02. The total number of media to be played back is set to a variable N in step S02, and the flow shifts to step S03. In step S03, N is set as an initial value for a variable n representing the number of media undergoing playback processing. This means that playback processing is executed for all media data in the initial state. Then, the flow advances to step S04.

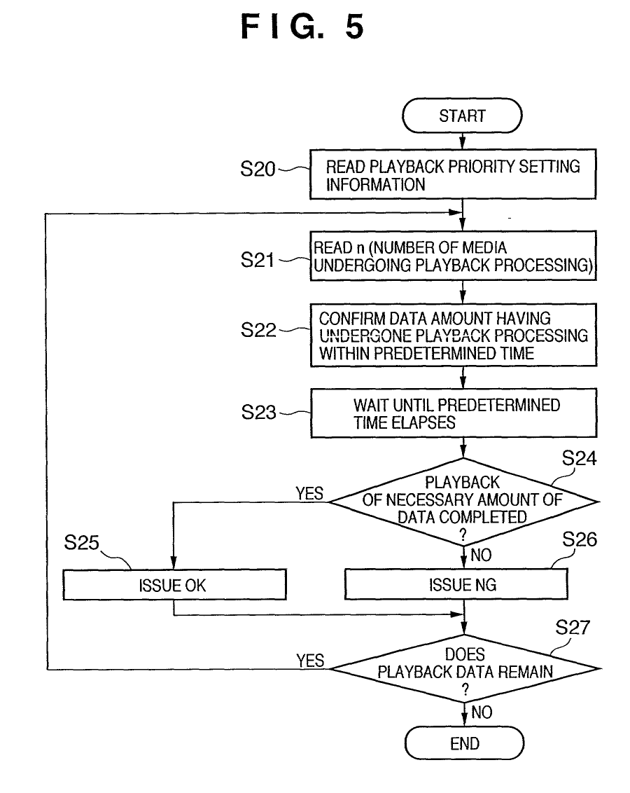

In step S04, measurement information which is generated by another monitoring process and represents whether playback processing will be completed is read. This measurement information is generated over a longer span than the playback processing loop shown in FIG. 4, so the measurement information may not exist even if the information is to be read in step S04. The measurement contents will be described in detail below with reference to the flow chart of FIG. 5.

In step S05, whether the measurement information to be read in step S04 exists is checked. If YES in step S05, the flow shifts to step S06; if NO, to step Step S06 is executed when playback processing measurement information exists in step S05. If the playback speed is determined to be sufficient as a result of measurement, the flow advances to step S07; if the playback speed is determined to be insufficient, to step S09. In step S07, the number n of media undergoing playback processing is compared with the total number N of media. If N=n, all media have already been played back, the number of media to be played back need not be increased, and thus the flow shifts to step S11. If N>n, the flow shifts to step S08. Note that N<n does not hold, so the flow does not branch under this condition.

Step S08 is executed when N>n in step S07. Since the processing speed is sufficient at this time, the number of media to be played back is increased by one. For this purpose, the number n of media undergoing playback processing is increased by one in step S08. After that, the flow advances to step S11.

Step S09 is executed when the playback speed is determined in step S06 to be insufficient. Whether the number n of media undergoing playback processing is smaller than 0 is checked. If n=0, no media are played back at this time, and the flow advances to step S11; if n>0, to S10. Note that n<0 does not hold, so the flow does not branch under this condition. Step S10 is executed when n>0 in step S09. Since the processing speed is insufficient at this time, the number of media to be played back is decreased by one. For this purpose, the number n of media undergoing playback processing is decreased by one in step S10. Then, the flow advances to step S11.

Step S11 is executed after processing in steps S05 to S10. Whether the number n of media subjected to playback processing is larger than 0 is checked. If n >0, the flow shifts to step S12 in order to perform playback processing for n media; if n=0, playback processing is not performed, and the flow skips step S12 and shifts to step S13. Note that n<0 does not hold, so the flow does not branch under this condition. Step S12 is executed when one or more playback processes exist in step S1, and playback processing is executed for n media for a predetermined time. Thereafter, the flow advances to step S13.

In step S13, whether media which have not undergone playback processing exist is checked, and the number n of media undergoing playback processing is compared with the total number N of media. If n<N, media which have not undergone playback processing exist, and the flow advances to step S14. If N=n, media which have not undergone playback processing do not exist, and the flow skips step S14 and advances to step S15. Note that N<n does not hold, so the flow does not branch under this condition. Step S14 is executed when media which have not undergone playback processing are determined in step S13 to exist. A comment representing that these media have not undergone playback processing is displayed. After that, the flow shifts to step S15.

Step S15 is executed after steps S11 to S14 where playback processing ends and the comment for the non-playback media is displayed. Whether data to be played back remains is determined. If playback is in progress at this time and will continue for a while, the flow returns to step S04; if all data have been played back, the flow ends.

The processing contents of the monitoring process of measuring whether playback processing will be completed will be explained with reference to the flow chart of FIG. 5. FIG. 5 is a flow chart showing monitoring processing for playback processing according to the first embodiment.

In FIG. 5, processing priority setting information described with reference to FIG. 3 is read out from the memory device 2 in FIG. 1 in step S20, and the flow advances to step S21. The number n of media undergoing playback processing at this time is read in step S21, and the flow shifts to step S22.

In step S22, the data amount of n media which will undergo playback processing during a predetermined time from the current time is confirmed and set, and the flow advances to step S23. In step S23, the flow waits for the predetermined time and then shifts to step S24.

Step S24 is executed after the predetermined time set in step S23. At this time, whether playback of the data amount confirmed and set in step S22 is completed is checked. If YES in step S24, the flow shifts to step S25; if NO, to step S26. Step S25 is executed when the necessary amount of data has been played back within the predetermined time in step S24. The above-described playback processing is notified of playback speed OK information so as to use this information as measurement information in step S04 of FIG. 4. Then, the flow advances to step S27. Step S26 is executed when the necessary amount of data has not been played back within the predetermined time in step S24. The above-described playback processing is notified of playback speed NG information so as to use this information as measurement information in step S04 of FIG. 4. Then, the flow advances to step S27.

Step S27 is executed at the end of monitoring playback processing within a predetermined time. Whether data to be played back remains is determined. If playback is in progress at this time and will continue for a while, the flow returns to step S21; if all data have been played back, the flow ends.

The contents of the above-described processing will be exemplified. In this example, processing is done for one moving picture, one still picture, one text, and one sound, as shown in FIG. 2.

The operator manipulates the pointing device 5 on a selection menu (not shown) to display the playback priority setting dialog 100 shown in FIG. 3, and sets the priorities of media data. In the following description, the operator selects the moving picture, still picture, sound, and text for priorities 1, 2, 3, and 4, respectively, as shown in FIG. 3. After setting the priorities, the operator clicks the OK button 109 to store the setting contents in the memory device 2 via the CPU 1. Unless the contents are reset, the setting contents are read out from the memory device 2 and used for playback prioritization in playing back multimedia.

The operator selects the start of playback on the selection menu (not shown) with the pointing device 5 to start the multimedia playback control process shown in FIG. 2. At the same time as the start, the control process in FIG. 4 is read out from the memory device 2 and executed by the CPU 1. At the same time, the monitoring process of measuring the playback processing speed, as shown in the flow chart of FIG. 5, is read out from the memory device 2 into the CPU 1 and executed.

In step S00, the playback control process reads control data necessary for playing back a plurality of media in synchronism with each other. In step S01, the playback priority setting information saved in the memory device 2 is read out. In step S02, N=4 is set because the total number of media is 4: one moving picture, one still picture, one text, and one sound. In step S03, n=4 is set as the initial value for the number of media undergoing playback processing because the total number N of media is 4.

The playback control process shifts to step S04. At this time, playback just starts, so no information is sent from the monitoring process. As a result of determination in step S05, the playback control process shifts to step S1. Since n>0 in step S11, the playback control process shifts to step S12. In step S12, media of priorities 1 to 4, i.e., all the media are to be played back. Read of moving picture data, still picture data, text data, and sound data starts via the data reading device 6 or network device 8. At the same time, the CPU 1 performs playback processing, the display device 7 displays the moving picture, still picture, and text, and the loudspeaker 9 plays back the sound. The playback control process advances to step S13. Since n=N, the playback control process skips processing in step S14 and advances to step S15. Playback has not been completed yet at this time, so the playback control process returns to step S04 to repeat the playback processing loop.

The monitoring process (FIG. 5) activated simultaneously is executed parallel to the playback process. Processing priority setting information is read in step S20, and the number n of media undergoing playback processing at this time is read in step S21. At first, n=4, i.e., all the media are played back. In step S22, the processing data amount (i.e., data amount required to play back n media data) after a predetermined time is confirmed. The monitoring process waits for the predetermined time in step S23, and then whether playback processing of the data amount is completed is checked in step S24.

When the data transfer rate from the data reading device 6 or network device 8 is sufficiently high and the performance of the CPU 1 is sufficiently high, data playback processing is completed without any problem. Hence, the monitoring process shifts to step S25 as a result of determination in step S24, and playback OK information is sent as measurement information to step S04. To the contrary, when the data transfer rate from the data reading device 6 or network device 8 is low or the performance of the CPU 1 is low, playback processing of the necessary data is not completed. The monitoring process shifts to step S26 as a result of determination in step S24, and playback NG information is sent as measurement information to step S04. Since playback does not end at this time, the monitoring process returns from step S27 to step S21 to continue monitoring the playback status.

While playback continues for a given time, the playback control process receives the measurement information representing the playback status from the monitoring process in step S04. As a result, the playback control process advances from step S05 to step S06. If the playback speed is sufficient, the playback control process shifts to step S07. Since n=4 at this time, the playback control process shifts to step S11 to continue playback without any change.

If the playback speed is insufficient, the playback control process advances to step S09. Since n=4 at this time, the playback control process shifts to step S10 as a result of determination in step S09, and n is changed from 4 to 3 in step S10. In step S12 via step S11, media data of priorities 1 to 3, i.e., only three, moving picture, still picture, and sound are to be played back. These three media data are read and played back, and no text data is read and played back. This gives margins to the data transfer rate from the data reading device 6 or network device 8 and the playback ability of the CPU 1, and subsequent processing may be completed within a predetermined time.

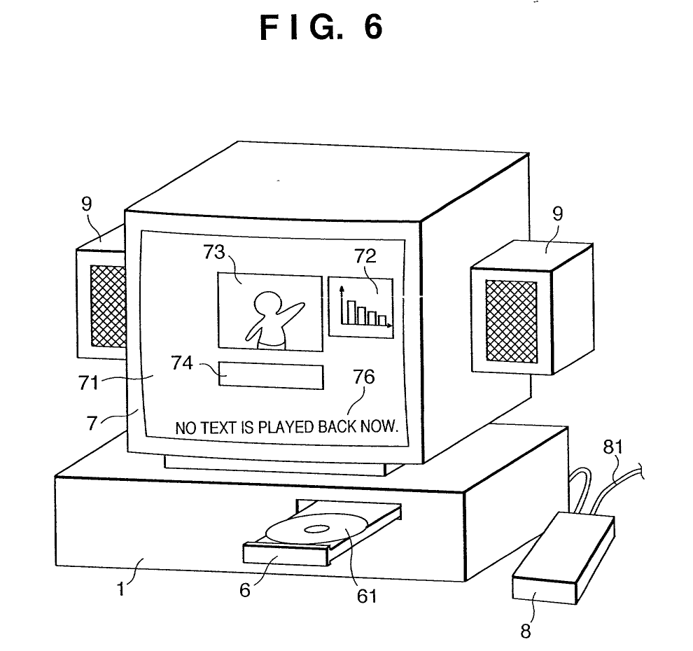

A message representing that playback processing of the text data stops is displayed in step S14 via step S13, and the playback loop is repeated. FIG. 6 is a view showing this state. In FIG. 6, the same reference numerals as in FIG. 2 denote the same parts, and a repetitive description thereof will be omitted. In FIG. 6, no data is displayed in the text region 74, and the playback stop message (in this case, the message representing that playback of the text data stops) is displayed at a portion 76.

While the playback process shown in FIG. 4 continues, the monitoring process shown in FIG. 5 also continues monitoring every predetermined period. If the playback speed is determined to be insufficient, n is changed from 3 to 2 in step S10. Only the moving and still pictures are played back in step S12, and a message representing that playback of the sound and text stops is displayed in step S14.

To the contrary, if the data transfer status improves or another program executed by the CPU 1 ends, and multimedia can be played back without any problem, n is increased by one in step S08, the number of media data to be played back in step S12 is increased by one, and the number of playback stop messages displayed in step S14 is decreased by one.

As described above, when the multimedia playback status is monitored and playback delays, the number of media to be played back is decreased one by one in accordance with the priorities set in advance by the operator. When the playback speed becomes sufficiently high, media which are inhibited from being played back are played back one by one. Hence, a limited number of media data can be played back in the order desired by the operator even in a poor data transfer environment or on a poor-performance personal computer.

Note that steps S13 and S14 can be omitted when no playback processing stop message is displayed.

In this embodiment, only one medium exists for each type of medium. When a plurality of media of the same type exist (e.g., two moving pictures are to be displayed), priorities may be set for the respective media (e.g., priorities 1 and 2 are set for moving picture 1 and moving picture 2, respectively).

In this embodiment, playback/stop can only be selected. Depending on the media, the quality can be changed to cope with the playback ability. For example, for a moving picture, moving picture data having a plurality of qualities are prepared in the data storage medium 61 or on a network. For a high data transfer ability or good performance of the CPU 1, high-quality moving picture data is used; for a low data transfer ability or poor performance of the CPU 1, low-quality moving picture data is used. In this case, not only the item “playback/stop” but also an item “increase/decrease the quality” may be added to operator's choices of priorities. Media data whose playback quality can be adjusted include a moving picture, still picture, and sound.

In this case, for example, playback/stop of a moving picture and high/low quality of a moving picture are respectively set to priorities 1 and 2. For n=2 in processing of FIG. 4, a moving picture is played back with a high quality. However, when the n changes from “2” into “1”, the moving picture comes to be played back with a low quality. Further, the playback of the moving picture stops when the n changes from “1” into “0”. Alternatively, playback/stop of a moving picture, playback/stop of a still picture, and high/low quality of a moving picture may be respectively set to priorities 1, 2, and 3. For n=3, a moving picture is played back with a high quality. However, when the n changes from “3” into “2”, the moving picture comes to be played back with a low quality. Further, when the n changes from “2” into “1”, display of a still picture stops. Furthermore, when the n changes from “1” into “0”, playback of the low quality moving picture stops.

If given media data is played back with low playback quality, a message to this effect is preferably displayed. For example, “The playback quality of the moving picture is lowered now.” is displayed at the display portion 76 shown in FIG. 6. That is, if playback is limited to stop of playback or low-quality playback, the user is preferably notified of a message to this effect.

As described above, according to this embodiment, the operator can set priorities for playing back a plurality of media. When multimedia playback cannot be completed in time, the number or quality of media to be played back is controlled in accordance with the priorities. Accordingly, media can be played back as much as possible in the order desired by the operator in accordance with the performance and data transfer rate of a personal computer which plays back media.

The present invention may be applied to a system constituted by a plurality of devices (e.g., a host computer, interface device, reader, and printer) or an apparatus comprising a single device (e.g., a notebook personal computer).

The object of the present invention is also achieved when a storage medium (or recording medium) which stores software program codes for realizing the functions of the above-described embodiment is supplied to a system or apparatus, and the computer (or the CPU or MPU) of the system or apparatus reads out and executes the program codes stored in the storage medium. In this case, the program codes read out from the storage medium realize the functions of the above-described embodiment, and the storage medium which stores the program codes constitutes the present invention. The functions of the above-described embodiment are realized not only when the computer executes the readout program codes, but also when the operating system (OS) running on the computer performs part or all of actual processing on the basis of the instructions of the program codes.

The functions of the above-described embodiment are also realized when the program codes read out from the storage medium are written in the memory of a function expansion card inserted into the computer or the memory of a function expansion unit connected to the computer, and the CPU of the function expansion card or function expansion unit performs part or all of actual processing on the basis of the instructions of the program codes.

As has been described above, the present invention can set priorities for data to be simultaneously played back and when playback processing delays, limit playback of data from a low priority.

As many apparently widely different embodiments of the present invention can be made without departing from the spirit and scope thereof, it is to be understood that the invention is not limited to the specific embodiments thereof except as defined in the claims.

What is claimed is:

1. An information processing apparatus comprising:
playback means for playing back a plurality of pieces of media information;
monitoring means for monitoring a playback status of the plurality of pieces of media information in said playback means;
storage means for storing priority information representing priorities of the plurality of pieces of media information; and
limiting means for limiting playback of the media information in said playback means on the basis of a playback status monitoring result of said monitoring means and the priority information.

2. The apparatus according to claim 1, further comprising designation means for designating the priorities for a plurality of media.

3. The apparatus according to claim 1, further comprising notifying means for, when media information limited in playback by said limiting means exists, representing that the media information limited in playback exists.

4. The apparatus according to claim 1, wherein limitation of playback by said limiting means includes stop of playback of media information.

5. The apparatus according to claim 1, wherein limitation of playback by said limiting means includes a decrease in playback quality of media information.

6. The apparatus according to claim 1, further comprising return means for returning a playback state of the media information limited by said limiting means to a normal state on the basis of the playback status monitoring result of said monitoring means and the priority information.

7. The apparatus according to claim 2, wherein
said limiting means has a plurality of types of executable limitation items, and
said designation means can set a priority for each pair of a type of media information and a limitation item.

8. The apparatus according to claim 1, wherein said monitoring means monitors whether processing of a media information amount to be played back is completed within a predetermined time.

9. The apparatus according to claim 8, wherein when said monitoring means represents that processing of the media information amount to be played back is not completed within the predetermined time, said limiting means inhibits said playback means from playing back media information given a low priority based on the priority information.

10. The apparatus according to claim 9, further comprising display means for, when media information limited in playback by said limiting means exists, displaying that the media information limited in playback exists.

11. The apparatus according to claim 9, wherein when media information limited in playback exists and said monitoring means represents that processing of the media information amount to be played back is completed within the predetermined time, said limiting means enables playback of media information having a high priority out of the playback-inhibited media information.

12. The apparatus according to claim 8, wherein when said monitoring means represents that processing of the media information amount to be played back is not completed within the predetermined time, said limiting means decreases playback quality of media information having a low priority in said playback means.

13. An information processing method comprising:
the playback step of playing back a plurality of pieces of media information;
the monitoring step of monitoring a playback status of the plurality of pieces of media information in the playback step;
the storage step of storing priority information representing priorities of the plurality of pieces of media information; and
the limiting step of limiting playback of the media information in the playback step on the basis of a playback status monitoring result in the monitoring step and the priority information.

14. The method according to claim 13, further comprising the designation step of designating the priorities for a plurality of media.

15. The method according to claim 13, further comprising the notifying step of, when media information limited in playback in the limiting step exists, representing that the media information limited in playback exists.

16. The method according to claim 13, wherein limitation of playback in the limiting step includes stop of playback of media information.

17. The method according to claim 13, wherein limitation of playback in the limiting step includes a decrease in playback quality of media information.

18. The method according to claim 13, further comprising the return step of returning a playback state of the media information limited in the limiting step to a normal state on the basis of the playback status monitoring result in the monitoring step and the priority information.

19. The method according to claim 14, wherein
the limiting step has a plurality of types of executable limitation items, and
a priority can be set for each pair of a type of media information and a limitation item in the designation step.

20. The method according to claim 13, wherein in the monitoring step, whether processing of a media information amount to be played back is completed within a predetermined time is monitored.

21. The method according to claim 20, wherein when processing of the media information amount to be played back is represented in the monitoring step not to be completed within the predetermined time, media information given a low priority based on the priority information is inhibited in the limiting step from being played back in the playback step.

22. The method according to claim 21, further comprising the display step of, when media information limited in playback in the limiting step exists, displaying that the media information limited in playback exists.

23. The method according to claim 21, wherein when media information limited in playback exists and processing of the media information amount to be played back is represented in the monitoring step to be completed within the predetermined time, playback of media information having a high priority out of the playback-inhibited media information is enabled in the limiting step.

24. The method according to claim 20, wherein when processing of the media information amount to be played back is represented in the monitoring step not to be completed within the predetermined time, playback quality of media information having a low priority in the playback step is decreased in the limiting step.

25. A computer-readable memory which stores a computer program for causing a computer to execute an information processing method having:
the playback step of playing back a plurality of pieces of media information;
the monitoring step of monitoring a playback status of the plurality of pieces of media information in the playback step;
the storage step of storing priority information representing priorities of the plurality of pieces of media information; and
the limiting step of limiting playback of the media information in the playback step on the basis of a playback status monitoring result in the monitoring step and the priority information.

26. A computer program for causing a computer to execute an information processing method having:
the playback step of playing back a plurality of pieces of media information;
the monitoring step of monitoring a playback status of the plurality of pieces of media information in the playback step;
the storage step of storing priority information representing priorities of the plurality of pieces of media information; and
the limiting step of limiting playback of the media information in the playback step on the basis of a playback status monitoring result in the monitoring step and the priority information.
